(19) United States
(12) Patent Application Publication
(10) Pub. No.: US 2025/0198404 A1
(43) Pub. Date: Jun. 19, 2025

(54) Packing Leakage Detection and Packing Status Monitoring System and Method in a Plunger Pump

(71) Applicant: YANTAI JEREH OILFIELD SERVICES GROUP CO., LTD., Yantai (CN)

(72) Inventors: Yibo JIANG, Yantai (CN); Hailong LI, Yantai (CN)

(73) Assignee: YANTAI JEREH OILFIELD SERVICES GROUP CO., LTD., Yantai (CN)

(21) Appl. No.: 19/072,144

(22) Filed: Mar. 6, 2025

Related U.S. Application Data
(63) Continuation-in-part of application No. 18/639,703, filed on Apr. 18, 2024.
Application No. 18/639,703 is a continuation of application No. PCT/CN2021/142529, filed on Dec. 29, 2021.

(30) Foreign Application Priority Data
Nov. 29, 2021 (CN) 202111437307.4
Sep. 30, 2024 (CN) 202411389198.7

(51) Int. Cl. F04B 51/00; G01M 3/26

(52) U.S. Cl. CPC F04B 51/00; G01M 3/26

(57) ABSTRACT

The present disclosure relates to the field of oil and gas recovery equipment technologies and provides a method and apparatus for monitoring a packing status of a plunger pump. The method may include packing pressures at packing cavities in a hydraulic-end valve box of the plunger pump through at least one packing pressure detector mounted at the packing cavities; obtaining a discharge pressure of the hydraulic-end valve box; and monitoring the packing status of the plunger pump based on the discharge pressure of the hydraulic-end valve box and the packing pressures at the packing cavities. As such, a packing failure can be accurately identified, prompting timely repair and protection. Damage to a body of the hydraulic-end valve box caused by packing failure is thus reduced, thereby reducing risk of pump failure and facilitating pump maintenance.

### CROSS-REFERENCE TO RELATED APPLICATIONS

This application is based on and claims the benefit of priority to U.S. patent application Ser. No. 18/639,703, filed on Apr. 18, 2024, which is a continuation application and claims the benefit of priority to PCT International Application No. PCT/CN2021/142529, filed on Dec. 29, 2021, which is based on and claims priority to Chinese Patent Application No. 202111437307.4, entitled “PACKING LEAKAGE DETECTION SYSTEM AND METHOD” and filed with the China National Intellectual Property Administration on Nov. 29, 2021. This application is further based on and claims the benefit of priority to Chinese Patent Application No. 202411389198.7, filed on Sep. 30, 2024. All of these prior patent applications are incorporated herein by reference in their entireties.

### TECHNICAL FIELD

This application relates generally to the field of oil and gas devices, and particularly to a packing leakage detection and packing status monitoring system and method.

### BACKGROUND

With the continuous development of the petroleum industry, plunger pumps are increasingly widely used in oilfield wellsite operations. For example, high-pressure plunger pumps are employed during fracturing and oilfield water injection operations. Fracturing involves injecting high displacement fracturing fluid into a well, causing artificial fractures in water and oil layers, and then injecting propping agents to increase the yield. Because oil wells exploited over a long time may experience stoppages and residual dead oil, resulting in difficulties in further exploitation, water injection may become necessary in order to increase the pressure of the oil layer to continue operations.

A plunger pump may include a power end and a hydraulic end, the power end may be implemented as a crank slider worm gear type or a planetary gear transmission type according to different forms of motion mechanisms, and the power end drives a spindle to perform a rotary motion which is then converted into a reciprocating motion of a plunger. Through the reciprocating motion of the plunger, the plunger pump converts a low-pressure mixed solution entering from a liquid inlet end into a high-pressure mixed solution to be discharged. In this process, a packing and a plunger connecting rod are dynamically sealed, and the sealing is achieved by virtue of radial expansion of the packing. A long-term circulation and repetition of low pressure and high pressure causes distortion, damage and other phenomena of the packing, thus may seriously affect the operating efficiency and even cause accidents.

Currently, repair and maintenance methods, such as manual inspection, video surveillance, planned maintenance, and emergency repair, are mainly used at operation sites of oil and gas fields. During manual inspection, since an area in which devices are located is a high-pressure area, personnel cannot enter the area, and inspections are performed at intervals (for example, the inspection is performed every 30 minutes). Due to a long inspection distance and a time interval between inspections, dripping leakage, piercing leakage, and the like cannot be found in time, which easily causes piercing leakage of a hydraulic-end valve box of a device body. When video surveillance is used, surveillance images from cameras mounted on a device side are checked. However, there are a plurality of pumps at a site, it is unlikely to perceive leakage of a single cylinder of a single pump, especially when the pump is far from the camera. In addition, video surveillance is greatly affected by surveillance checking personnel. For example, the personnel may work a night shift or not pay attention, and possibly cannot find leakage in time, which may easily cause piercing leakage of the hydraulic-end valve box of the device body. Planned maintenance requires operation personnel to check existence of leakage in all pieces of packing of tens or even dozens of pumps on site. Under such a maintenance system, the personnel need to check the pumps one by one and cylinders one by one, which is time-and-labor-consuming and is blind. Emergency repair is rescue repair performed after a failure accident occurs on a device. Such repair usually means that the device cannot work normally, and a part needs to be replaced. In this case, all on-site devices need to be shut down, which affects a work progress and efficiency on site.

### SUMMARY

This application provides a packing leakage detection system and method to solve the problem of delayed detection/warning of abnormal packing leakage or other failures.

According to a first aspect, an embodiment of this application provides a packing leakage detection system, including a plunger pump, a pressure sensor and a control system, where the pressure sensor is configured to detect a pressure value inside a hydraulic end of the plunger pump, and send the detected pressure value to the control system; and the control system is configured to acquire the pressure value sent by the pressure sensor, and send prompt information according to the pressure value, where the prompt information includes at least one of alarm information and information for prompting shutdown and overhaul.

Optionally, the pressure sensor is arranged within a preset area where the distance from a grease injection hole is less than a preset distance value, where the grease injection hole is located on a housing of the hydraulic end, and the grease injection hole is configured to connect an automatic lubrication system.

Optionally, the packing leakage detection system further includes a one-way valve, a three-way joint and a straight joint; and an input end of the grease injection hole is connected to the automatic lubrication system, an output end of the grease injection hole is connected to a first end of the one-way valve, a second end of the one-way valve is connected to a first end of the three-way joint, a second end of the three-way joint is connected to a first end of the pressure sensor, a second end of the pressure sensor is connected to the control system, a third end of the three-way joint is connected to a first end of the straight joint, and a second end of the straight joint is connected to a packing component of the hydraulic end.

Optionally, a connecting hole is arranged in a circumferential position of the grease injection hole, and the pressure sensor is arranged on the connecting hole.

Optionally, at least one grease injection hole is provided, and at least one pressure sensor is provided.

Optionally, the control system is specifically configured to judge whether the pressure value is greater than a preset pressure value, and send the prompt information in a case that the pressure value is greater than the preset pressure value.

According to a second aspect, an embodiment of this application provides a packing leakage detection method, including: acquiring a pressure value inside a hydraulic end of a plunger pump; and sending prompt information according to the pressure value, where the prompt information includes at least one of alarm information and information for prompting shutdown and overhaul.

Optionally, the sending prompt information according to the pressure value includes: judging whether the pressure value is greater than a preset pressure value; and sending the prompt information in a case that the pressure value is greater than the preset pressure value.

Optionally, after the acquiring a pressure value inside a hydraulic end of a plunger pump, the method further includes: recording the pressure value.

Optionally, after the recording the pressure value, the method further includes: displaying the pressure value.

According to a third aspect, an embodiment of this application provides a packing leakage detection apparatus, including: an acquisition module, configured to acquire a pressure value inside a hydraulic end of a plunger pump; and a processing module, configured to send prompt information according to the pressure value, where the prompt information includes at least one of alarm information and information for prompting shutdown and overhaul.

Optionally, the processing module includes: a first processing sub-module, configured to judge whether the pressure value is greater than a preset pressure value; and a second processing sub-module, configured to send the prompt information in a case that the pressure value is greater than the preset pressure value.

Optionally, the packing leakage detection apparatus further includes: a recording module, configured to record the pressure value.

Optionally, the packing leakage detection apparatus further includes: a display module, configured to display the pressure value.

According to a fourth aspect, an embodiment of this application provides an electronic device, including: a processor, a memory and a communication bus, where the processor and the memory communicate with each other through the communication bus; the memory is configured to store a computer program; and the processor is configured to execute the program stored in the memory to implement the packing leakage detection method according to the second aspect.

According to a fifth aspect, an embodiment of this application provides a computer-readable storage medium storing a computer program, and the computer program, when executed by a processor, implements the packing leakage detection method according to the second aspect.

Compared with the prior art, the technical solutions provided in the embodiments of this application have the following advantages: in the embodiments of this application, a packing leakage detection system is provided, including the plunger pump, the pressure sensor and the control system, where the pressure sensor is configured to detect a pressure value inside a hydraulic end of the plunger pump, and send the detected pressure value to the control system; and the control system is configured to acquire the pressure value sent by the pressure sensor, and send prompt information according to the pressure value, where the prompt information includes at least one of alarm information and information for prompting shutdown and overhaul. In this application, the pressure value inside the hydraulic end of the plunger pump is detected through the pressure sensor, the pressure value can reflect a leakage anomaly caused by a packing failure in time, and the prompt information is sent according to the pressure value through the control system to prompt a user of the leakage anomaly caused by the packing failure in time to overhaul in time, thus avoiding major safety accidents and effectively preventing a valve box from being damaged due to leakage to solve the problem of delayed detection/warning of abnormal packing leakage or other failures.

### BRIEF DESCRIPTION OF THE DRAWINGS

Accompanying drawings herein are incorporated into the specification and constitute a part of the specification, show embodiments that conform to the present invention, and are used for explaining the principle of the present invention together with the specification.

In order to more clearly illustrate the technical solutions in the embodiments of the present invention or in the prior art, the accompanying drawings are briefly introduced below. A person of ordinary skill in the art can derive other accompanying drawings from these accompanying drawings without creative efforts.

FIG. 1 is a schematic structural diagram of a plunger pump in the prior art;

FIG. 2 is a schematic structural diagram of a packing in the plunger pump in the prior art;

FIG. 3 is a schematic structural diagram of a packing leakage detection system in an embodiment of this application;

FIG. 4 is a schematic structural diagram of the packing leakage detection system in a specific embodiment of this application;

FIG. 5 is a schematic flowchart of a packing leakage detection method in an embodiment of this application;

FIG. 6 is a schematic flowchart of the packing leakage detection method in a specific embodiment of this application;

FIG. 7 is a schematic structural diagram of a packing leakage detection apparatus in an embodiment of this application;

FIG. 8 is a schematic structural diagram of an electronic device in an embodiment of this application;

FIG. 9 shows a flowchart of a method for monitoring a packing status of a plunger pump according to an embodiment of the present disclosure;

FIG. 10 is a schematic structural diagram of a plunger pump according to an embodiment of the present disclosure;

FIG. 11 is a cross-sectional view of a hydraulic-end valve box of a plunger pump according to an embodiment of the present disclosure;

FIG. 12 is a schematic partially enlarged structural diagram (a part indicated by a circle A in FIG. 11) of a packing cavity in FIG. 11;

FIG. 13 is a schematic enlarged structural diagram of packing according to an embodiment of the present disclosure;

FIG. 14 is a schematic structural diagram of first arrangement of a packing pressure detector on a hydraulic-end valve box;

FIG. 15 is a schematic structural diagram of second arrangement of a packing pressure detector on a hydraulic-end valve box;

FIG. 16 is a schematic enlarged structural diagram (a part indicated by a circle B in FIG. 1) of a trigger wheel in FIG. 9;

FIG. 17 shows a flowchart of a method for monitoring a packing status of a plunger pump according to an embodiment of the present disclosure;

FIG. 18 shows a flowchart of a method for monitoring a packing status of a plunger pump according to an embodiment of the present disclosure; and

FIG. 19 is a schematic structural diagram of an apparatus for monitoring a packing status of a plunger pump according to an embodiment of the present disclosure.

Description of reference numerals: 1—hydraulic end assembly, 2—power end assembly, 3—plunger pump, 4—pressure sensor, 5—control system, 6—lubrication grease injection hole, 7—automatic lubrication system, 8—one-way valve, 9—three-way joint, 10—straight joint, 11—packing component, 12—plunger, 13—cable (e.g., electric cable for transmitting sensor signal), and 14—packing gland nut.

### DETAILED DESCRIPTION

Various solutions and features of the present disclosure are described herein with reference to the accompanying drawings.

It should be understood that various modifications may be made to the embodiments of the present disclosure. Therefore, the foregoing specification should not be considered as a limitation, but is merely an example of embodiments. A person skilled in the art will conceive of other modifications within the scope and spirit of the present disclosure.

The accompanying drawings included in the specification and constituting a part of the specification show embodiments of the present disclosure and are, together with general descriptions of the present disclosure provided above and detailed descriptions of the embodiments provided below, used for describing a principle of the present disclosure.

These and other characteristics of the present disclosure will become apparent from the following descriptions of preferred forms of embodiments that are given as non-limiting examples with reference to the accompanying drawings.

It should be further understood that although the present disclosure has been described with reference to some specific examples, a person skilled in the art can definitely implement many other equivalent forms of the present disclosure, and the equivalent forms have the features described in the claims and therefore, all fall within the protection scope defined by the claims.

With reference to the accompanying drawings, in view of the following detailed descriptions, the foregoing and other aspects, features, and advantages of the present disclosure will become more apparent.

The specific embodiments of the present disclosure are described below with reference to the accompanying drawings. However, it should be understood that the claimed embodiments are merely examples of the present disclosure, and may be implemented in a plurality of manners. Well-known and/or repeated functions and structures are not described in detail, to avoid obscuring the present disclosure with unnecessary or redundant details. Therefore, specific structural and functional details claimed in this specification are not intended to be limiting, but are merely used as a basis and a representative basis for the claims to teach a person skilled in the art to use the present disclosure in various ways with substantially any suitable detailed structure.

In this specification, phrases “in an embodiment”, “in another embodiment”, “in still another embodiment”, or “in other embodiments” may all be used to refer to one or more of the same or different embodiments of the present disclosure.

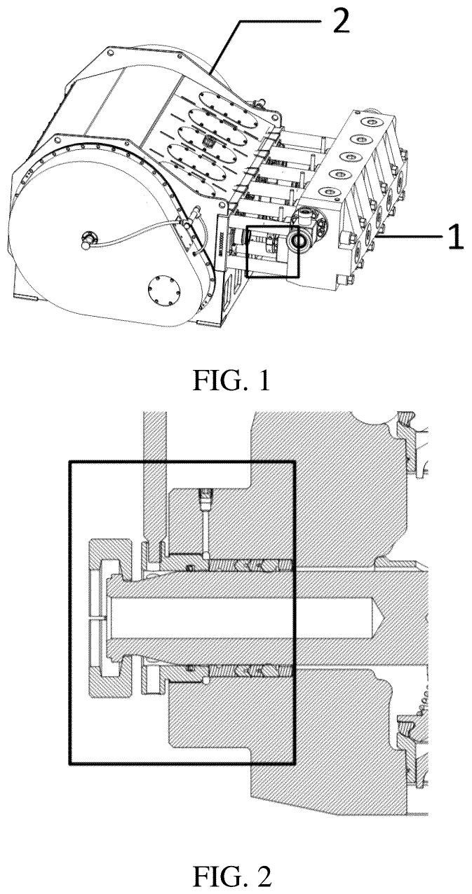

By analyzing a plunger pump in the prior art, the inventors found that: FIG. 1 shows a schematic structural diagram of a plunger pump, the plunger pump includes a hydraulic end assembly 1 and a power end assembly 2, the power end assembly 2 provides power to the hydraulic end assembly 1, the hydraulic end assembly 1 is responsible for pressurizing and then discharging a mixed solution composed of sand and other liquids, and a packing assembly is a component in the hydraulic end assembly 1, which performs the functions of wear reduction, sealing and leakage prevention. In FIG. 2, a schematic structural diagram of a packing in the plunger pump is shown in a rectangular box. FIG. 2 corresponds to the rectangular box indicated in FIG. 1.

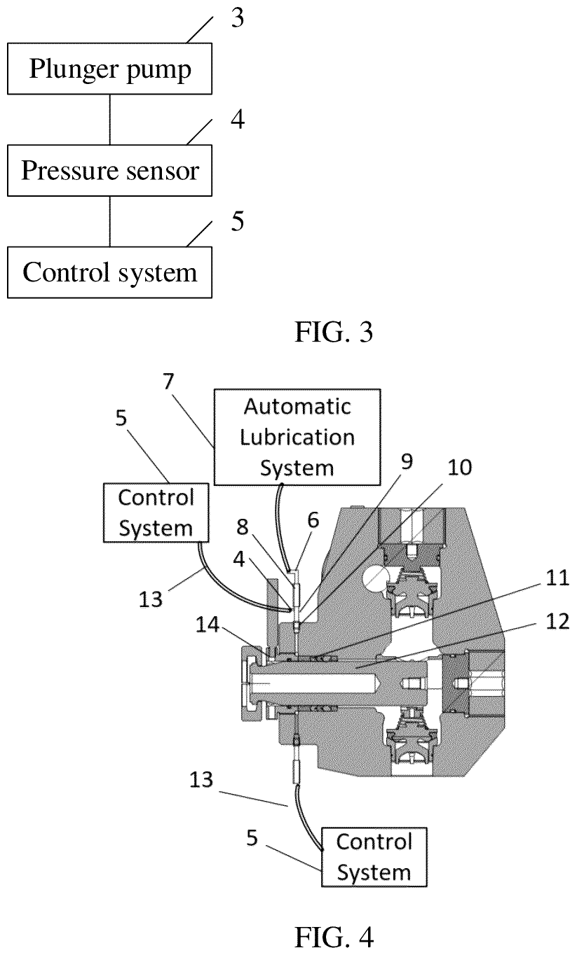

In an embodiment of this application, as shown in FIG. 3, a packing leakage detection system is provided, including a plunger pump 3, a pressure sensor 4 and a control system 5.

The pressure sensor 4 is configured to detect a pressure value inside a hydraulic end of the plunger pump 3, and send the detected pressure value to the control system 5.

The control system 5 is configured to acquire the pressure value sent by the pressure sensor 4, and send prompt information according to the pressure value, where the prompt information includes at least one of alarm information and information for prompting shutdown and overhaul.

In this application, the pressure value inside the hydraulic end of the plunger pump is detected through the pressure sensor, the pressure value can reflect a leakage anomaly caused by a packing failure in time, and the prompt information is sent according to the pressure value through the control system to prompt a user of the leakage anomaly caused by the packing failure in time to stop or overhaul the system in time, thereby avoiding major safety accidents and effectively preventing a valve box (at a fracturing fluid end, as described further below, and labeled as 1 in FIG. 1) for controlling low-pressure and high-pressure fracturing fluid from being damaged due to leakage. The example solution above thus help solve the problem that a leakage anomaly caused by a packing failure is often not discovered in time.

In a specific embodiment, as shown in FIG. 4, the pressure sensor 4 may be arranged within a preset area where the distance from a grease injection hole 6 is less than a preset distance value. The grease injection hole 6 may be located on a housing of the hydraulic end, and the grease injection hole 6 may be configured to connect to an automatic lubrication system 7. The term “grease” is used to refer to, for example, lubrication grease or lubrication oil, that may be applied to the plunger (12 of FIG. 4) for lubrication in the dynamic sealing between the plunger and the packing component inner wall (at 11 of FIG. 4, for example) as the plunger reciprocates as it is driven by the power end (left of FIG. 4).

The preset distance value may be an empirical value or a numerical value obtained by multiple tests.

In the example implementation above, an original structure of the hydraulic end need not be changed, and the pressure sensor 4 is arranged at or near the original grease injection hole 6 configured to connect the automatic lubrication system 7 to detect the pressure value inside the hydraulic end of the plunger pump 3. The structure is simple, and the overhaul is facilitated.

In a specific embodiment, as shown in FIG. 4, the packing leakage detection system further includes a one-way valve 8, a three-way joint 9 and a straight joint 10.

An input end of the grease injection hole 6 is connected to the automatic lubrication system 7, an output end of the grease injection hole 6 is connected to a first end of the one-way valve 8, a second end of the one-way valve 8 is connected to a first end of the three-way joint 9, a second end of the three-way joint 9 is connected to a first end of the pressure sensor 4, a second end of the pressure sensor 4 is connected to the control system 5, a third end of the three-way joint 9 is connected to a first end of the straight joint 10, and a second end of the straight joint 10 is connected to a packing component 11 of the hydraulic end.

Through the reciprocating motion of a plunger 12, the plunger pump converts a low-pressure mixed solution entering from a liquid inlet end into a high-pressure mixed solution to be discharged. In this process, the packing component 11 and the plunger 12 are dynamically sealed, and the sealing is achieved by virtue of radial expansion of the packing component 11. A packing gland nut 14 is configured to maintain the sealing performance of the packing component 11.

The second end of the pressure sensor 4 is connected to the control system 5 through a cable 13.

By connecting the second end of the three-way joint 9 to the first end of the pressure sensor 4, the pressure sensor 4 can detect a pressure value of a contact part between the packing component 11 and the plunger 12 inside the hydraulic end. Specifically, such contact part should dynamically seal between the wall of the packing component 11 and the plunger 12 under normal operations. As such, the lubrication line along the lubrication grease/oil injection hole, the one-way valve 8, the three-way joint 9, and the pressure sensor 4 (alternatively referred to as the lubricating side (or lubricating cavity) of the plunger in the hydraulic end 1) should be sealed against and hydraulically separate from the valve box containing the fracturing fluid (alternatively referred to as fracturing fluid end, or front cavity side of the plunger in the hydraulic end 1). The pressure value measured by the pressure sensor 4 would not be affected by the pressure at the front cavity side under normal operations. However, in case of sealing failure or leakage between the inner wall of the packing component 11 and the plunger 12, the lubricating side and the frond end side of the plunger would be hydraulically connected through the failed sealing, and the pressure sensor 4 would then read at least partially the pressure from the front end side, which would be different from the pressure in the lubricating side without sealing failure or leakage of the packing component, thereby providing a mechanism for leakage detection.

For example, when the automatic lubrication system 7 injects lubricating grease under normal operations, the pressure is about 20 MPa on the lubricating side (e.g., within the fluid path of 8, 4, 9, and 10 of FIG. 4), indicating that the contact part between the packing component 11 and the plunger 12 is a pressure cavity for lubricant grease without leaking from or to the fracturing fluid (the fracturing fluid side or frond cavity side, right side of the plunger 12 of FIG. 4). When the sealing of the packing fails, however, the high pressure inside the front cavity of the hydraulic end (fracturing fluid side, e.g., right side of the plunger 12 of FIG. 4) will reach the lubrication grease pressure cavity (the lubricating side) along the direction of the arrow, that is, from right to left. Due to the fact that the pressure inside the front cavity of the hydraulic end is much higher than the pressure in the lubrication grease line when the automatic lubrication system 7 injects the lubricating grease at this time, the pressure in the lubricating cavity will exhibit high pressure (e.g., higher than the normal, e.g., 20 MPa). As a result, the pressure sensor 4 detects a pressure value and transmits the detected pressure value to the control system 5, and the control system 5 provides prompt information, where the prompt information includes at least one of alarm information and information for prompting shutdown and overhaul.

In some example implementations, at least one grease injection hole 6 is provided, and at least one pressure sensor 4 is provided. More pressure sensors can be employed to detect a more accurate pressure value and can further prompt a user of the leakage anomaly caused by the packing failure in time to overhaul in time, thereby avoiding major safety accidents and effectively preventing a valve box from being damaged due to leakage and achieving good economy.

In FIG. 4, an entire packing leakage detection system including the one-way valve 8, the three-way joint 9, the pressure sensor 4, the cable 13, the control system 5 and the straight joint 10 is connected between the space above the packing component 11 and the grease injection hole 6. Only one set of pressure sensor 4, the cable 13 and the control system 5 are shown in the space above the packing component 11, merely as an example. In some implementations, another grease injection hole 6 may also be arranged on a housing of a hydraulic end below the packing component 11, either as alternative or addition. An entire packing leakage detection system including the one-way valve 8, the three-way joint 9, the pressure sensor 4, the cable 13, the control system 5 and the straight joint 10 may be connected between the space below the packing component 11 and the another grease injection hole 6. FIG. 4 shows a situation that two pressure sensors 4 are arranged. According to the position distribution of the grease injection hole 6, the pressure sensor 4 may also be arranged in another position. Multiple set of pressure sensors and grease injections holes may be arranged.

In a specific example embodiment, a connecting hole may be arranged in a circumferential position of the grease injection hole 6, and the pressure sensor 4 is arranged on the connecting hole.

In some example implementations, a new connecting hole may be formed in the circumferential position of the grease injection hole 6, and the pressure sensor 4 may be connected to the connecting hole. An original structure of the hydraulic end need not be changed, and the pressure sensor 4 may be arranged by the original grease injection hole 6 configured to connect the automatic lubrication system 7 to detect the pressure value inside the hydraulic end of the plunger pump 3. The structure is simple, and an overhaul or stoppage in case of packing leakage is facilitated.

At least one grease injection hole 6 may be provided, and likewise, at least one pressure sensor 4 may be provided. More pressure sensors can detect a more accurate pressure value and can further prompt a user of the leakage anomaly caused by the packing failure in time to overhaul in time, thereby avoiding major safety accidents and effectively preventing the valve box from being damaged due to leakage to achieve good economy.

In a specific example embodiment, the control system 5 is specifically configured to judge whether a pressure value is greater than a preset pressure value. In a case that the pressure value is greater than the preset pressure value, prompt information is sent, where the prompt information includes at least one of alarm information and information for prompting shutdown and overhaul.

The preset pressure value may be an empirical value or a numerical value obtained by multiple tests. The preset pressure value may relate to a threshold level of the leakage and the operational pressure in the valve box. The preset pressure value is used as a threshold for indicating a leakage anomaly caused by a packing failure. When the pressure value is greater than the preset pressure value, it indicates that a leakage anomaly caused by a packing failure may have occurred. At this time, prompt information may be generated and sent to give an alarm or prompt shutdown and overhaul to prompt a user of the leakage anomaly caused by the packing failure in time to overhaul in time, thereby avoiding major safety accidents and effectively preventing the valve box from being damaged due to leakage to solve the problem of delayed detection/warning of abnormal packing leakage or other failures. In some other implementations, the threshold value may be programmable. It may be adjusted during the operation life of the plunger pump. It may be adjusted according to the pressure in the valve box measured or detected by other pressure sensors.

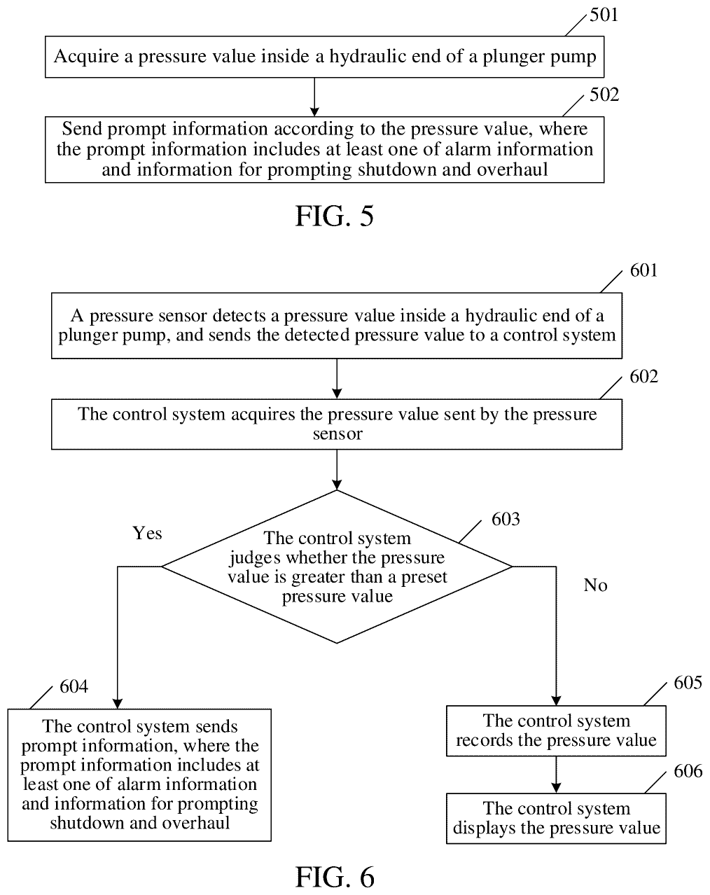

Based on the same concept, as shown in FIG. 5, an embodiment of this application provides a packing leakage detection method applied to a control system 5. The packing leakage detection method mainly includes the following processes:
Step 501: A pressure value inside a hydraulic end of a plunger pump is acquired.

The acquisition of the pressure value inside the hydraulic end of the plunger pump (in the lubricating side, or lubricating cavity, in particular) may be acquisition of a pressure value sent by a pressure sensor 4.

In a specific embodiment, after the pressure value inside the hydraulic end of the plunger pump is acquired, the packing leakage detection method further includes: the pressure value is recorded.

By recording the pressure value in real time, the pressure change after leakage at the packing can be recorded.

In a specific embodiment, after the pressure value is recorded, the packing leakage detection method further includes: the pressure value is displayed.

After the pressure value is recorded, the pressure value is displayed, so that the pressure change after leakage at the packing can be visually presented accurately and precisely.
Step 502: Prompt information is sent according to the pressure value, where the prompt information includes at least one of alarm information and information for prompting shutdown and overhaul.

In a specific embodiment, prompt information is sent according to a pressure value, including: whether the pressure value is greater than a preset pressure value is judged; and in a case that the pressure value is greater than the preset pressure value, the prompt information is sent.

The preset pressure value may be an empirical value or a numerical value obtained by multiple tests. The preset pressure value is used for indicating a leakage anomaly caused by a packing failure. When the pressure value is greater than the preset pressure value, it indicates that a leakage anomaly caused by a packing failure may have occurred. At this time, prompt information is sent to give an alarm or prompt shutdown and overhaul to prompt a user of the leakage anomaly caused by the packing failure in time to overhaul in time, thus avoiding major safety accidents and effectively preventing a valve box from being damaged due to leakage to solve the problem of delayed detection/warning of abnormal packing leakage or other failures.

After receiving the prompt information, the user can stop the operation of the plunger pump for overhaul. After the overhaul is completed and the plunger pump returns to normal, the plunger pump continues to operate under load, and then, the pressure sensor continues to detect the pressure value inside the hydraulic end of the plunger pump to continue to perform the processes of the packing leakage detection method.

In a specific embodiment, as shown in FIG. 6, a packing leakage detection method includes the following processes:
Step 601: A pressure sensor detects a pressure value inside a hydraulic end of a plunger pump (in the lubricating side, or lubricating cavity, in particular), and sends the detected pressure value to a control system.
Step 602: The control system acquires the pressure value sent by the pressure sensor.
Step 603: The control system judges whether the pressure value is greater than a preset pressure value, where in a case that the pressure value is greater than the preset pressure value, step 604 is performed, otherwise, step 605 is performed.
Step 604: The control system sends prompt information, where the prompt information includes at least one of alarm information and information for prompting shutdown and overhaul.
Step 605: The control system records the pressure value.
Step 606: The control system displays the pressure value.

In this application, the pressure value inside the hydraulic end of the plunger pump is detected through the pressure sensor, the pressure value can reflect a leakage anomaly caused by a packing failure in time, and the prompt information is sent according to the pressure value through the control system to prompt a user of the leakage anomaly caused by the packing failure in time to overhaul in time, thus avoiding major safety accidents and effectively preventing a valve box from being damaged due to leakage to solve the problem of delayed detection/warning of abnormal packing leakage or other failures.

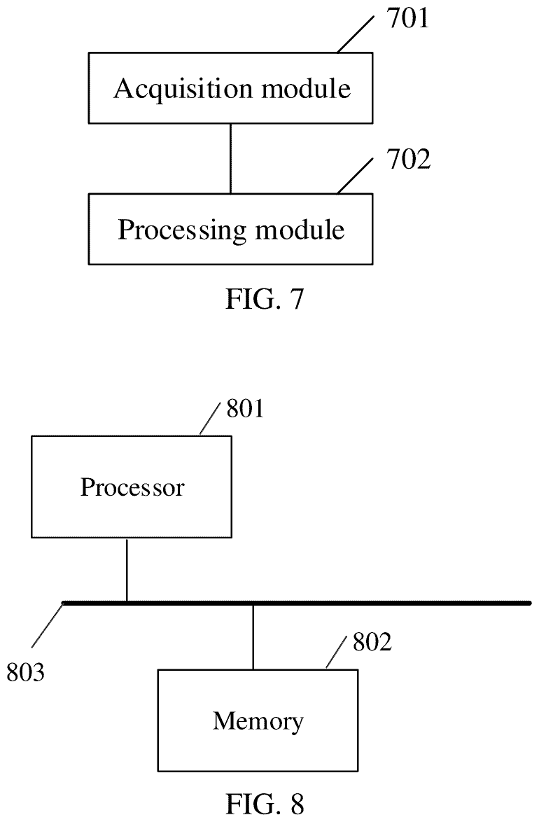

Based on the same concept, an embodiment of this application provides a packing leakage detection apparatus. The specific implementations of the apparatus can refer to the descriptions of method embodiments, and the repeated content will not be described. As shown in FIG. 7, the apparatus mainly includes:
an acquisition module 701, configured to acquire a pressure value inside a hydraulic end of a plunger pump; and
a processing module 702, configured to send prompt information according to the pressure value, where the prompt information includes at least one of alarm information and information for prompting shutdown and overhaul.

Optionally, the processing module includes:
a first processing sub-module, configured to judge whether the pressure value is greater than a preset pressure value; and
a second processing sub-module, configured to send the prompt information in a case that the pressure value is greater than the preset pressure value.

Optionally, the packing leakage detection apparatus further includes:
a recording module, configured to record the pressure value.

Optionally, the packing leakage detection apparatus further includes:
a display module, configured to display the pressure value.

Various example for monitoring packing leaking is further shown below.

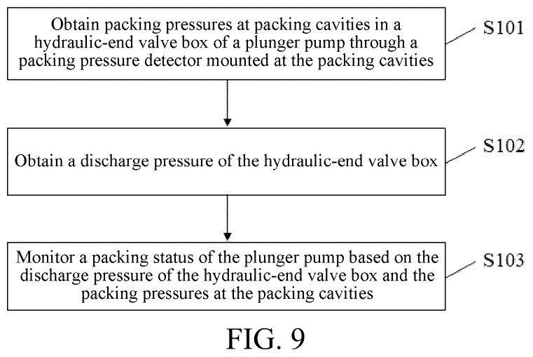

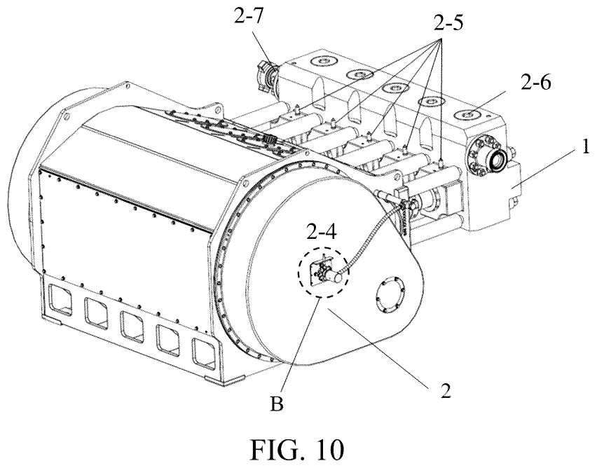

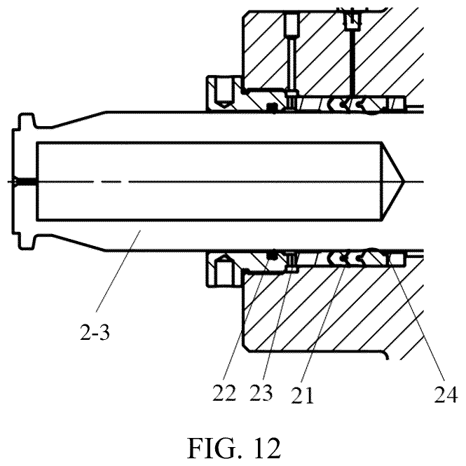

FIG. 9 shows an example flowchart of a method for monitoring a packing status of a plunger pump according to an embodiment of the present disclosure. FIG. 10 to FIG. 16 are schematic structural diagrams of a plunger pump and monitoring components (including a pressure detector, a discharge pressure sensor, a running detector, and the like) according to an embodiment of the present disclosure. As shown in FIG. 9 to FIG. 16, an embodiment of the present disclosure provides a method for monitoring a packing status of a plunger pump, including the following steps.
S101: Obtain packing pressures at packing cavities in a hydraulic-end valve box of a plunger pump through a packing pressure detector mounted at the packing cavities.

As shown in FIG. 9 to FIG. 16, the plunger pump includes a hydraulic end and a power end. The hydraulic end includes a hydraulic-end valve box 2-1. A packing cavity 2-2 is arranged in the hydraulic-end valve box 2-1. One end of a plunger 2-3 is located in the packing cavity 2-2, and another end thereof extends out of the hydraulic-end valve box 2-1 and is connected to the power end. The power end includes components such as a crankshaft 2-4. In this step, an accurate packing pressure value can be detected and obtained in real time through a pressure detector 2-5 arranged at the packing cavity 2-2.

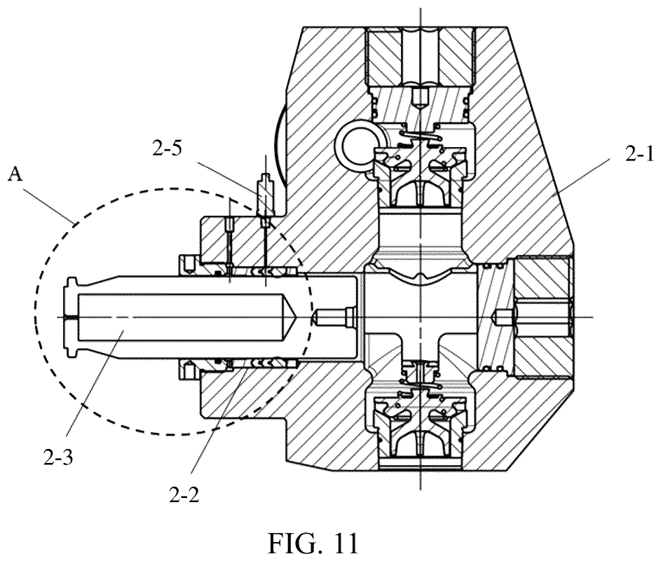

As shown in FIG. 11 to FIG. 13, the packing cavity 2-2 includes a contact position between the hydraulic-end valve box 2-1 and packing 21, a contact position between the hydraulic-end valve box 2-1 and a packing pressing cap 22, a contact position between the hydraulic-end valve box 2-1 and a packing pressing ring 23, and a contact position between the hydraulic-end valve box 2-1 and a packing isolating ring 24.

The packing 21 of the plunger pump includes a piece of soft packing and two pieces of hard packing, namely, first hard packing 211, second hard packing 212, and soft packing 212. The hard packing has a V-shaped lip 214 and an opening facing a direction of a high-pressure cavity of the hydraulic-end valve box 2-1.

Packing sealing is self-sealing and is also a contact sealing, and its sealing function is mainly that V-shaped lips 214 of two pieces of hard packing in the packing 21 are opened by a pressure of liquid delivered in a high-pressure cavity of the hydraulic end to come into tight contact with a surface of the plunger and an inner wall of the packing cavity 2-2 of the hydraulic-end valve box to perform sealing. The soft packing 212 mainly implements a supporting function. If the packing 21 is not damaged, when the pressure of the liquid delivered by the hydraulic-end valve box 2-1 reaches a specific pressure, the pressure of the delivered liquid tightly presses the packing 21, to enlarge the openings of the V-shaped lips 214 of the packing, which implement a pressure-assisted sealing function on the packing 21. After the packing 21 is sealed, a pressure is maintained within a particular pressure range after the first hard packing 211. After the packing 21 is damaged, the pressure herein has different values due to different sizes of damage. Therefore, in this embodiment, packing damage monitoring is performed according to this characteristic, so that an abnormality of a packing 21 can be identified in advance.

The term “V-shaped” is used to broadly refer to a cross section of the packings or packing components 211 and 212 having a narrower merged tip side and a wider opening side. The actual cross-sectional shape need not exactly resemble a “V”. The packings may be implemented in a ‘U” shape, a half circle, or any other shapes having a narrower merged tip and a wider opening. The term “V-shaped” or “V-shape” is used to cover all such implementations.

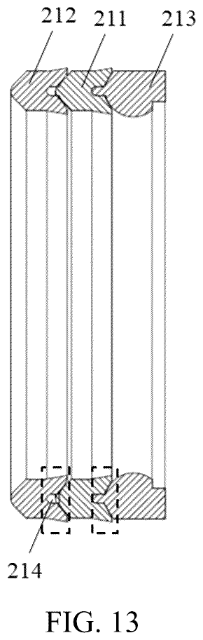

Preferably, the pressure detector 2-5 is arranged at a position of the V-shaped lip of the first hard packing and/or a position of the V-shaped lip of the second hard packing (a position of a dashed-line box in FIG. 13), to detect a pressure change at an easily damaged part of the packing 21 more precisely and sensitively.

The hydraulic-end valve box 2-1 includes a plurality of cylinders 2-6 (for example, including five cylinders). Each cylinder includes a packing cavity 2-2 and a plunger 2-3.

In some embodiments, first pressure sensors 51 are respectively mounted at all the packing cavities 2-2, and in step S101, the obtaining packing pressures at packing cavities through a packing pressure detector 2-5 includes:
Obtain a packing pressure of a corresponding packing cavity 2-2 through the first pressure sensor 51 arranged at the packing cavity 2-2.

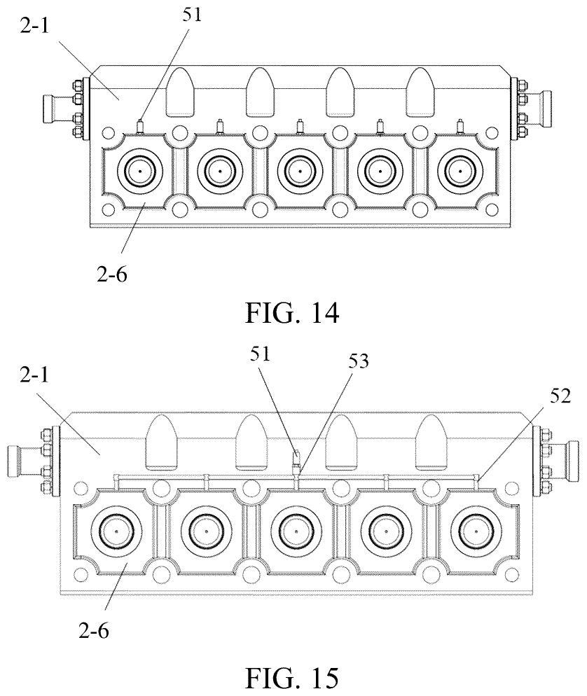

In this step, as shown in FIG. 14, the first pressure sensor 51 may be arranged at each packing cavity 2-2, to detect a pressure of the packing cavity 2-2 corresponding to the first pressure sensor (packing pressure sensor) 51. One or more first pressure sensors 51 may be arranged in each packing cavity 2-2. When a plurality of first pressure sensors 51 are arranged at a single packing cavity 2-2, for example, one first pressure sensor 51 is arranged at the position of the V-shaped lip of the first hard packing, and one first pressure sensor 51 is arranged at the position of the V-shaped lip of the second hard packing, accuracy of pressure detection is further ensured.

In some other embodiments, pressure connectors 52 are respectively mounted at all the packing cavities 2-2, the pressure connectors 52 are respectively connected to a pressure collection module 53, and a first pressure sensor 51 is arranged on the pressure collection module 53. In step S101, the obtaining packing pressures at packing cavities through a packing pressure detector includes:
Obtain a pressure of the pressure collection module 53 through the first pressure sensor 51, where cylinders 2-6 of the hydraulic-end valve box 2-1 operate alternately, and the pressure of the pressure collection module 53 is a packing pressure of a packing cavity 2-2 of a currently operating cylinder 2-6;
Determine the packing pressures at the packing cavities 2-2 according to the pressure of the pressure collection module 53.

As shown in FIG. 15, because the cylinders 2-6 of the hydraulic-end valve box 2-1 work alternately, pressure connectors 52 may be respectively arranged at all the packing cavities 2-2, and pressures at the packing cavities 2-2 are collected to the pressure collection module 53 by using the pressure connectors 52. The first pressure sensor 51 arranged on the pressure collection module 53 is configured to obtain a packing pressure at a packing cavity 2-2 of a currently working cylinder 2-6, so that in combination with alternate working of the cylinders 2-6, packing pressures at the packing cavities 2-2 may be obtained alternately by the first pressure sensor 51, thereby reducing a quantity of arranged first pressure sensors 51 and pressure detection costs.

In this step, if the cylinders 2-6 operate alternately in sequence, a packing cavity 2-2 corresponding to a pressure detected by the first pressure sensor 51 can be determined based on a preset working sequence of the cylinders. If the cylinders 2-6 do not have a particular working sequence, a currently working cylinder 2-6 needs to be determined, and further, a packing cavity 2-2 corresponding to a pressure currently detected by the first pressure sensor 51 is determined, so that a packing pressure of the corresponding packing cavity 2-2 can be obtained through real-time detection based on the currently working cylinder 2-6.
S102: Obtain a discharge pressure of the hydraulic-end valve box.

As shown in FIG. 9, a discharge pressure of the hydraulic-end valve box 2-1 is a discharge pressure of the plunger pump, and can be obtained by a second pressure sensor (discharge pressure sensor) 2-7 arranged on a side of a flange at a discharge end of the hydraulic-end valve box 2-1. Alternatively, the discharge pressure may be directly obtained by a device end. For example, when the plunger pump operates, a display module on the hydraulic-end valve box 2-1 displays the discharge pressure of the hydraulic-end valve box 2-1.
S103: Monitor a packing status of the plunger pump based on the discharge pressure of the hydraulic-end valve box and the packing pressures at the packing cavities.

Because the packing 21 is affected by a pressure of liquid delivered by the hydraulic-end valve box 2-1, in this step, the packing pressures at the packing cavities 2-2 may be analyzed with reference to the discharge pressure of the hydraulic-end valve box 2-1, to identify a status of the packing 21 in time and accurately, monitor the packing status of the plunger pump, and find a packing failure in time, thereby facilitating timely repair and protection. If it is detected that the packing 21 is normal, no processing is needed. If it is detected that the packing 21 is abnormal, it is determined that the packing 22 may be damaged, and needs to be handled timely.

In the method for monitoring a packing status of a plunger pump provided by this embodiment of the present disclosure, the packing pressures at the packing cavities 2-2 in the hydraulic-end valve box 2-1 of the plunger pump are obtained through the packing pressure detector 2-5 mounted at the packing cavities 2-2, the discharge pressure of the hydraulic-end valve box 2-1 is obtained, and the packing status of the plunger pump is monitored based on the discharge pressure of the hydraulic-end valve box 2-1 and the packing pressures at the packing cavities 2-2, so that a packing status can be identified timely and accurately, a packing failure can be found timely, repair and protection can be carried out timely, damage to a body of the hydraulic-end valve box caused by packing damage is reduced, and a service life of the valve box is further prolonged. In addition, sudden failure and shutdowns of the plunger pump caused by packing failures are reduced, and use efficiency of the plunger pump on site is improved, so that running of the plunger pump is more stable and reliable, maintenance is more targeted and is more convenient, and maintenance time and maintenance costs are reduced.

It may be understood that step S101 and step S102 may be sequentially performed according to preset execution steps, or may be simultaneously performed. A specific execution sequence is not specifically limited in the present disclosure.

In some embodiments, in step S103, the monitoring a packing status of the plunger pump based on the discharge pressure of the hydraulic-end valve box and the packing pressures at the packing cavities includes:
Determine whether the discharge pressure reaches a packing-assisted sealing pressure;
If the discharge pressure reaches the packing-assisted sealing pressure, determine whether the packing pressure exceeds a preset packing pressure threshold;
If the packing pressure exceeds the preset packing pressure threshold, determine that the packing is abnormal.

When packing status detection is performed, it is first determined whether the discharge pressure of the hydraulic-end valve box 2-1 reaches a packing-assisted sealing pressure, and if the discharge pressure of the hydraulic-end valve box 2-1 does not reach the packing-assisted sealing pressure, the pressure of the liquid delivered inside the hydraulic-end valve box 2-1 does not cause damage to the packing 21. If the discharge pressure of the hydraulic-end valve box 2-1 reaches the packing-assisted sealing pressure, the detected packing pressures at the packing cavities are compared with a preset packing pressure threshold, to determine whether a packing pressure exceeds the preset packing pressure threshold, and if the packing pressure exceeds the preset packing pressure threshold, it is determined that the packing 21 is abnormal, the packing 21 may be damaged or is about to be damaged, and so on. In this step, when the packing status is determined based on the detected packing pressures, it is first determined whether the discharge pressure of the hydraulic-end valve box 2-1 reaches the packing-assisted sealing pressure without performing determination on each of the detected packing pressures, which can effectively improve efficiency of packing status monitoring.

In some embodiments, the preset packing pressure threshold includes a plurality of thresholds determined based on packing abnormality levels, and in the above, the determining whether the packing pressure exceeds a preset packing pressure threshold includes:
comparing the packing pressure level by level with the preset packing pressure thresholds sorted in ascending order, and determining a status of the packing.

In this step, a plurality of determination thresholds may be determined based on an abnormality level (also referred to as a failure level or a damage level) of the packing 21, to accurately determine whether an abnormality exists in the packing and to determine an abnormality level after determining that an abnormality exists, in order to accurately determine a final abnormality status of the packing 21.

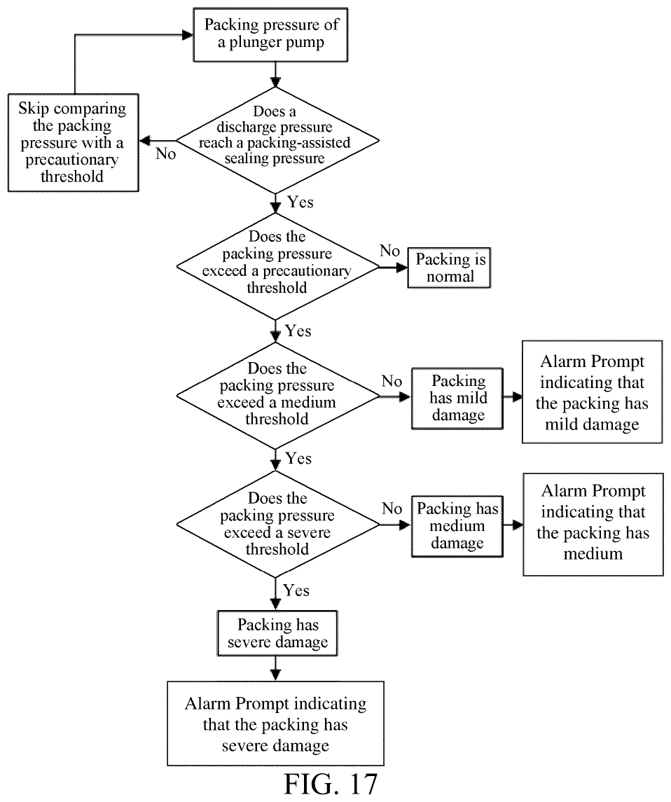

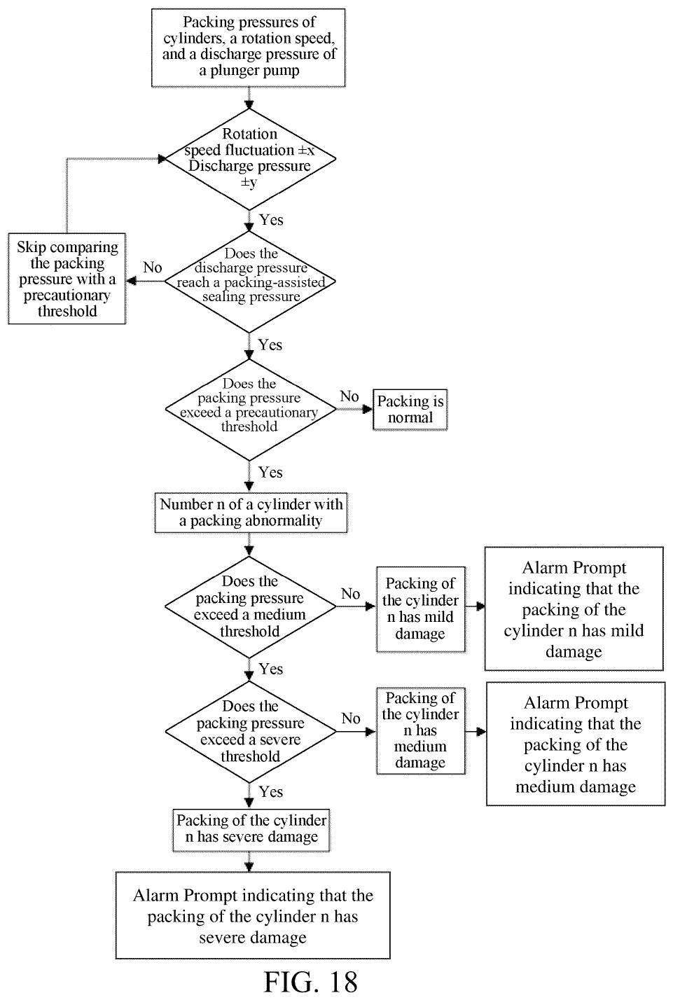

For example, as shown in FIG. 17 to FIG. 18, a first preset packing pressure threshold, a second preset packing pressure threshold, and a third preset packing pressure threshold may be set based on mild damage, medium damage, and severe damage of the packing. The first preset packing pressure threshold, the second preset packing pressure threshold, and the third preset packing pressure threshold sequentially increase. The first preset packing pressure threshold is a precautionary threshold, the second preset packing pressure threshold is a medium threshold, and the third preset packing pressure threshold is a severe threshold. When comparison is performed sequentially based on a detected packing pressure, the packing pressure may be first compared with the first preset packing pressure threshold. If the packing pressure is less than the first preset packing pressure threshold, it is determined that the packing is normal, and subsequent comparison does not need to be performed. If the packing pressure is greater than the first preset packing pressure threshold, it is determined that the packing is abnormal. In this case, the packing pressure is compared with the second preset packing pressure threshold. If the packing pressure is less than the second preset packing pressure threshold, it is determined that the packing 21 has mild damage. If the packing pressure is greater than the second preset packing pressure threshold, the packing pressure is compared with the third packing pressure threshold, to continue to determine a damage status of the packing 21. If the packing pressure is less than the third preset packing pressure threshold, it is determined that the packing 21 has medium damage. If the packing pressure is greater than the third preset packing pressure threshold, it is determined that the packing 21 has severe damage.

By comparing the packing pressure with the preset packing pressure thresholds level by level, not only an abnormality level of the packing 21 can be accurately determined, to facilitate subsequent corresponding processing, but also the abnormality level can be confirmed through a plurality of times of determination (the packing pressure is first compared with a packing pressure threshold corresponding to a low abnormality level, and when the packing pressure is greater than the packing pressure threshold corresponding to the low abnormality level, the packing pressure is compared with a packing pressure threshold corresponding to a higher abnormality level until a final abnormality level is determined), to avoid wrong determination, missed determination, mistaken determination, and the like.

In some other embodiments, the packing pressure may also be compared with preset packing pressure thresholds sorted in descending order level by level. For example, the packing pressure may be compared with the third preset packing pressure threshold first, to determine whether the packing is in a severely damaged state, and if the packing is in the severely damaged state, the packing is preferentially handled, to handle the severely damaged packing timely, thereby avoiding leakage of the liquid inside the plunger pump. If the packing is not in the severely damaged state, the packing pressure is compared with the second preset packing pressure threshold until a final status of the packing is determined.

In some other embodiments, a plurality of preset packing pressure ranges may be directly set based on the packing abnormality levels, a packing pressure range within which the packing pressure falls is determined, and a packing status is further directly determined. In this way, efficiency of packing status detection can be improved.

For example, if the packing pressure falls within a first packing pressure range, it is determined that the packing is normal. If the packing pressure falls within a second packing pressure range, it is determined that the packing has mild damage. If the packing pressure falls within a third packing pressure range, it is determined that the packing has medium damage. If the packing pressure falls within a fourth packing pressure range, it is determined that the packing has severe damage.

In some embodiments, before determining, through step S102, whether the discharge pressure reaches a packing-assisted sealing pressure, the method further includes the following steps:
Determine whether a running status of the plunger pump and the discharge pressure of the hydraulic-end valve box are stable.

Further, the determining whether the discharge pressure reaches a packing-assisted sealing pressure in step S102 includes:
If the running status of the plunger pump and the discharge pressure of the hydraulic-end valve box are stable, determine an operating condition of the plunger pump based on the running status of the plunger pump;
Determine, in the operating condition, whether the discharge pressure reaches the packing-assisted sealing pressure.

Before it is determined whether the discharge pressure reaches the packing-assisted sealing pressure, it is first determined whether the running status of the plunger pump and the discharge pressure of the hydraulic-end valve box 2-1 are stable. When it is determined that the running status of the plunger pump and the discharge pressure of the hydraulic-end valve box are stable, the discharge pressure is then compared with the packing-assisted sealing pressure, so that a sudden discharge pressure change caused by a sudden running change of the plunger pump caused by a sudden environmental change can be eliminated, thereby obtaining a more accurate discharge pressure determining result.

The hydraulic-end valve box 2-1 of the plunger pump have different discharge pressures in different operating conditions. Therefore, after it is determined that the running status of the plunger pump and the discharge pressure of the hydraulic-end valve box 2-1 are stable, a current operating condition of the plunger pump is determined based on the running status of the plunger pump, and it is determined, in the current operating condition, whether the discharge pressure reaches the packing-assisted sealing pressure. That is, different packing-assisted sealing pressures may be set based on different operating conditions of the plunger pump, to determine the discharge pressure of the hydraulic-end valve box 2-1, thereby obtaining a more accurate discharge pressure determining result.

In some embodiments, in the above, the determining whether a running status of the plunger pump is stable includes the following steps:
Obtain running status information of the plunger pump through a running detector arranged at one end of a crankshaft 2-4 of the plunger pump;
Determine, based on the running status information, whether the plunger pump runs stably.

The running status information of the plunger pump includes at least one of a running speed of the plunger pump, crank position information of the crankshaft of the plunger pump, and plunger position information. The plunger position information refers to position information of plungers of cylinders of the hydraulic-end valve box 2-1 when the plungers act.

Optionally, the running detector is a uniformly-toothed trigger wheel, or the running detector is a tooth-missing trigger wheel 2-8 and a key phase sensor 2-9.

A plurality of teeth are uniformly distributed on the uniformly-toothed trigger wheel, and the uniformly-toothed trigger wheel may be used to directly calculate a crankshaft rotation speed of the plunger pump.

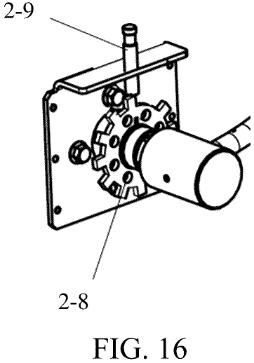

As shown in FIG. 9 and FIG. 16, the tooth-missing trigger wheel 2-8 and the key phase sensor 2-9 may be mounted at a free end of the crankshaft 2-4 of the plunger pump. A plurality of teeth are uniformly distributed on the tooth-missing trigger wheel 2-8, but one or more teeth are missing at a particular position, that is, “tooth-missing”. The tooth-missing trigger wheel 2-8 is mounted on the crankshaft 2-4 of the plunger pump, and is configured to generate a first pulse signal related to an angular position of the crankshaft. When the crankshaft 2-4 rotates, the key phase sensor 2-9 detects passing of a key phase, and generates a second pulse signal. The second pulse signal is used to combine with the first pulse signal of the tooth-missing trigger wheel 2-8, to determine, based on a rotation angle of the crankshaft, a motion position of each crank of the crankshaft of the plunger pump and plunger actions of the cylinders of the valve box at a current moment, thereby calculating the crankshaft rotation speed of the plunger pump.

In this embodiment, the tooth-missing trigger wheel 2-8 and the key phase sensor 2-9 cooperate to calculate plunger actions (plunger positions) of the cylinder of the valve box at a current moment, and may be further configured to determine a currently working cylinder 2-6 when the packing pressures at the packing cavities 2-2 are detected by using the pressure connectors 52, the pressure collection module 53, and the first pressure sensor 51, so that detection elements can be reduced, no additional working detector for the cylinder 2-6 needs to be arranged, and accuracy of a detection result is ensured.

The uniformly-toothed trigger wheel is applicable to the foregoing solution in which first pressure sensors 51 are arranged at all the packing cavities 2-2 (the first pressure sensors 51 are in a one-to-one correspondence with the packing cavities 2-2), so that detection elements can be reduced, steps of calculating the crankshaft rotation speed can be reduced, and efficiency of calculating the crankshaft rotation speed can be improved.

After the crankshaft rotation speed of the plunger pump is calculated, the crankshaft rotation speed of the plunger pump is used as the running speed of the plunger pump, and it is determined, based on the crankshaft rotation speed of the plunger pump, whether the plunger pump runs stably.

If the crankshaft rotation speed of the plunger pump fluctuates within a preset rotation speed fluctuation range (+x), it is determined that the plunger pump runs stably. Similarly, when it is determined whether the discharge pressure of the hydraulic-end valve box 2-1 is stable, it may be determined whether the discharge pressure of the hydraulic-end valve box 2-1 fluctuates within a preset discharge pressure fluctuation range (+y).

In the foregoing embodiment, the crankshaft rotation speed of the plunger pump is obtained through detection using the trigger wheel, and the detection is accurate and reliable. The trigger wheel can automatically adapt to a working environment of the plunger pump, to obtain more accurate running status information of the plunger pump, and the trigger wheel is conveniently deployed. In a specific implementation, the crankshaft rotation speed of the plunger pump can be obtained through another rotation speed detector, such as a speed sensor, arranged on the crankshaft 2-4.

In the foregoing embodiment, it is determined, based on the crankshaft rotation speed of the plunger pump, whether the plunger pump runs stably. In some other embodiments, it may be directly determined, based on position information of cranks of the crankshaft or the plunger position information, whether the plunger pump runs stably.

In some embodiments, the method further includes:
Generate corresponding alarm prompt information based on an abnormality status of the packing.

The alarm prompt information includes at least one of a cylinder with a packing abnormality, abnormality level information, and abnormality handling information.

After it is determined that the packing has an abnormality, and a specific abnormality level is determined, corresponding alarm prompt information may be generated, to prompt operation personnel to perform timely handling, to prevent a sudden failure and shutdown, and avoid a safety accident. The alarm prompt information may be output through an output apparatus such as an indicator light, a buzzer, a voice player, or a display. When the packing is in a normal state, no prompt may be provided, or corresponding prompt information may be generated. For example, an abnormality level of the packing may be indicated by a color of an indicator light, where red indicates severe damage, orange indicates medium damage, yellow indicates mild damage, and green indicates normal packing.

The abnormality handling information is an abnormality handling solution of the packing, including controlling an abnormal plunger to stop action, controlling the entire plunger pump to shut down, and so on, which helps a user to timely handle, according to alarm prompt information, the packing that has damage or that may have damage. Particularly, for novice operation personnel, it is convenient to handle an abnormality of the packing. The alarm prompt information may also be other prompt information, for example, may also be a specific damage thickness of the packing.

The method for monitoring a packing status of a plunger pump is described below in detail with reference to specific working processes of a plunger pump.

In some example implementations, referred to as embodiment 1, as shown in FIG. 14 and FIG. 17, first pressure sensors 51 are mounted at a position of a V-shaped lip of first hard packing and a position of a V-shaped lip of second hard packing of packing 21 at each packing cavity 2-2 at a hydraulic end (a hydraulic-end valve box 2-1) of a plunger pump, to obtain packing pressures at packing cavities 2-2 at the hydraulic end. A second pressure sensor 2-7 is mounted on a side of a flange at a discharge end of the hydraulic-end valve box 2-1, to obtain a discharge pressure of the hydraulic-end valve box 2-1 or read the discharge pressure of the hydraulic-end valve box 2-1 through a device end; determines whether the discharge pressure of the hydraulic-end valve box 2-1 reaches a packing-assisted sealing pressure of the plunger pump; if the discharge pressure does not reach the packing-assisted sealing pressure, skips performing comparison with a precautionary threshold; if the discharge pressure reaches the packing-assisted sealing pressure, determines through analysis whether a current packing pressure value exceeds the precautionary threshold; if the packing pressure value does not exceed the precautionary threshold, determines that packing is in a normal state, and outputs a result indicating the normal state; if the packing pressure exceeds the precautionary threshold, determines a hydraulic-end cylinder number n corresponding to the abnormal packing pressure based on marks of the first pressure sensors 51 mounted above the packing cavities 2-2 at the hydraulic end, and continues to determine whether the packing pressure exceeds a medium threshold; if the packing pressure does not exceed the medium threshold, determines that packing of a cylinder n has mild damage, and outputs alarm prompt information indicating “packing of the cylinder n has mild damage”; if the packing pressure exceeds the medium threshold, determines whether the packing pressure exceeds a severe threshold; if the packing pressure does not exceed the severe threshold, determines that the packing of the cylinder n has medium damage, and outputs alarm prompt information indicating “packing of the cylinder n has medium damage”; and if the packing pressure exceeds the severe threshold, determines that the packing of the cylinder n has severe damage, and outputs alarm prompt information indicating “packing of the cylinder n has severe damage”. The on-site operation personnel may perform processing timely according to the foregoing different alarm prompt information, to prevent a sudden failure and shutdown and the like.

Some other example implementations, referred to as embodiment 2, as shown in FIG. 9 and FIG. 15 to FIG. 17, may differs from the example implementations above in that: a tooth-missing trigger wheel 2-8 and a key phase sensor 2-9 are mounted at one end of a crankshaft 2-4 of the plunger pump, to obtain plunger actions of cylinders of the valve box of the plunger pump at a current moment. Pressure connectors 52 are mounted at a position of a V-shaped lip of first hard packing and a position of a V-shaped lip of second hard packing of the packing 21 at each packing cavity 2-2 at the hydraulic end of the plunger pump. The pressure connectors 52 of the cylinders is collected to a pressure collection module 53. A first pressure sensor 51 is mounted on the pressure collection module 53, and packing pressures at the packing cavities 2-2 at the hydraulic end are obtained with reference to the plunger actions of the cylinders of the valve box of the plunger pump at the current moment obtained through the tooth-missing trigger wheel 8 and the key phase sensor 2-9.

In yet some other example implementations, referred to as embodiment 3, as shown in FIG. 14 and FIG. 18, a uniformly-toothed trigger wheel is mounted at one end of a crankshaft 2-4 of a plunger pump, to obtain a crankshaft rotation speed of the plunger pump. First pressure sensors 51 are mounted at a position of a V-shaped lip of first hard packing and a position of a V-shaped lip of second hard packing of packing 21 above each packing cavity 2-2 at a hydraulic-end valve box 2-1, to obtain packing pressures at packing cavities 2-2 at the hydraulic end. A second pressure sensor 2-7 is mounted on a side of a flange at a discharge end of the hydraulic-end valve box 2-1, to obtain a discharge pressure of the hydraulic-end valve box 2-1 or read the discharge pressure of the hydraulic-end valve box 2-1 through a device end; determines whether a rotation speed of the plunger pump and the discharge pressure are stable; if the rotation speed of the plunger pump and the discharge pressure are stable, reads a discharge pressure of the plunger pump, and determines, with reference to the current rotation speed of the plunger pump, whether the discharge pressure of the plunger pump reaches a packing-assisted sealing pressure of the plunger pump in a current operating condition of the plunger pump; if the discharge pressure does not reach the packing-assisted sealing pressure, skips performing comparison with a precautionary threshold; if the discharge pressure reaches the packing-assisted sealing pressure, determines through analysis whether a current packing pressure value exceeds the packing precautionary threshold; if the packing pressure value does not exceed the precautionary threshold, determines that packing is in a normal state, and outputs a result indicating the normal state; if the packing pressure exceeds the precautionary threshold, determines a hydraulic-end cylinder number n corresponding to the abnormal packing pressure based on marks of the first pressure sensors 51 mounted above the packing cavities 2-2 at the hydraulic end, and continues to determine whether the packing pressure exceeds a medium threshold; if the packing pressure does not exceed the medium threshold, determines that packing of a cylinder n has mild damage, and outputs alarm prompt information indicating “packing of the cylinder n has mild damage”; if the packing pressure exceeds the medium threshold, determines whether the packing pressure exceeds a severe threshold; if the packing pressure does not exceed the severe threshold, determines that the packing of the cylinder n has medium damage, and outputs alarm prompt information indicating “packing of the cylinder n has medium damage”; and if the packing pressure exceeds the severe threshold, determines that the packing of the cylinder n has severe damage, and outputs alarm prompt information indicating “packing of the cylinder n has severe damage”. The on-site operation personnel may perform processing timely according to the foregoing different alarm prompt information, to prevent a sudden failure and shutdown and the like.

Embodiment 3 differs from Embodiments 1 in that: a step of determining whether a running status of the plunger pump and a discharge pressure of the hydraulic-end valve box 2-1 are stable is added, to accurately identify and determine a packing status for a current operating condition of the plunger pump. In Embodiment 3, it is determined, based on the crankshaft rotation speed of the plunger pump obtained by the uniformly-toothed trigger wheel, whether the running status of the plunger pump is stable.

In some other example implementations, referred to as embodiment 4, as shown in FIG. 9, FIG. 15, FIG. 16, and FIG. 18, Embodiment 4 differs from Embodiment 2 in that: a step of determining whether a running status of the plunger pump and a discharge pressure of the hydraulic-end valve box 2-1 are stable is added, to accurately identify and determine a packing status for a current operating condition of the plunger pump.

In Embodiment 4, the tooth-missing trigger wheel 2-8 and the key phase sensor 2-9 in Embodiment 2 are used to obtain a motion position of each crank of the crankshaft of the plunger pump and plunger actions of the cylinders of the valve box at a current moment, thereby calculating the crankshaft rotation speed of the plunger pump.

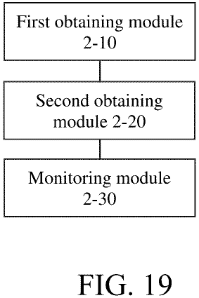

FIG. 19 is a schematic structural diagram of an apparatus for monitoring a packing status of a plunger pump according to an embodiment of the present disclosure. As shown in FIG. 19, based on the foregoing method for monitoring a packing status of a plunger pump, an embodiment of the present disclosure provides an apparatus for monitoring a packing status of a plunger pump, including:
a first obtaining module 2-10, configured to obtain packing pressures at packing cavities in a hydraulic-end valve box of a plunger pump through a packing pressure detector mounted at the packing cavities;
a second obtaining module 2-20, configured to obtain a discharge pressure of the hydraulic-end valve box; and
a monitoring module 2-30, configured to monitor a packing status of the plunger pump based on the discharge pressure of the hydraulic-end valve box and the packing pressures at the packing cavities.

In some embodiments, the packing cavity includes a contact position between the hydraulic-end valve box and packing, a contact position between the hydraulic-end valve box and a packing pressing cap, a contact position between the hydraulic-end valve box and a packing pressing ring, and a contact position between the hydraulic-end valve box and a packing isolating ring.

In some embodiments, a first pressure sensor is mounted at each of the packing cavities, and the first obtaining module 2-10 is further configured to obtain a packing pressure of a corresponding packing cavity through the first pressure sensor arranged at the packing cavity.

In some embodiments, first pressure connectors are respectively mounted at all the packing cavities, the first pressure connectors are respectively connected to a pressure collection module, and a first pressure sensor is arranged on the pressure collection module.

The first obtaining module 2-10 is further configured to obtain a pressure of the pressure collection module through the first pressure sensor, where cylinders of the hydraulic-end valve box work alternately, and the pressure of the pressure collection module is a packing pressure of a packing cavity of a currently working cylinder; and
determine the packing pressures at the packing cavities according to the pressure of the pressure collection module.

In some embodiments, the monitoring module 2-30 includes:
a first determining module, configured to determine whether the discharge pressure reaches a packing-assisted sealing pressure;
a second determining module, configured to determine, if the discharge pressure reaches the packing-assisted sealing pressure, whether the packing pressure exceeds a preset packing pressure threshold; and
a third determining module, configured to determine, if the packing pressure exceeds the preset packing pressure threshold, that the packing is abnormal.

In some embodiments, the preset packing pressure threshold includes a plurality of thresholds determined based on packing abnormality levels, and the monitoring module 2-30 is further configured to:
compare the packing pressure level by level with the preset packing pressure thresholds sorted in ascending order, and determine a status of the packing.

In some embodiments, the monitoring module 2-30 further includes a fourth determining module, configured to determine, before it is determined whether the discharge pressure reaches a packing-assisted sealing pressure, whether a running status of the plunger pump and the discharge pressure of the hydraulic-end valve box are stable. The first determining module is further configured to:
determine, if the running status of the plunger pump and the discharge pressure of the hydraulic-end valve box are stable, an operating condition of the plunger pump based on the running status of the plunger pump; and
determine, in the operating condition, whether the discharge pressure reaches the packing-assisted sealing pressure.

In some embodiments, the fourth determining module is further configured to:
obtain running status information of the plunger pump through a running detector arranged at one end of a crankshaft of the plunger pump, where the running status information of the plunger pump includes at least one of a running speed of the plunger pump, crank position information of the crankshaft of the plunger pump, and plunger position information, and the running detector is a uniformly-toothed trigger wheel, or the running detector is a tooth-missing trigger wheel and a key phase sensor; and determine, based on the running status information, whether the plunger pump runs stably.

In some embodiments, the apparatus for monitoring a packing status of a plunger pump further includes an alarm prompt module, configured to:
generate corresponding alarm prompt information based on an abnormality status of the packing, where
the alarm prompt information includes at least one of a cylinder with a packing abnormality, abnormality level information, and abnormality handling information.

The apparatus for monitoring a packing status of a plunger pump provided in this embodiment of the present disclosure corresponds to the method for monitoring a packing status of a plunger pump in the foregoing embodiments. Any option in the embodiment of the method for monitoring a packing status of a plunger pump is also applicable to the embodiment of the apparatus for monitoring a packing status of a plunger pump, and details are not described herein again.

Based on the concepts and principles above, an embodiment of this application further provides an electronic device. As shown in FIG. 8, the electronic device mainly includes: a processor 801, a memory 802 and a communication bus 803, where the processor 801 and the memory 802 communicate with each other through the communication bus 803. The memory 802 stores a program capable of being executed by the processor 801, and the processor 801 executes the program stored in the memory 802 to implement the following steps:
a pressure value inside a hydraulic end of a plunger pump is acquired; and prompt information is sent according to the pressure value, where the prompt information includes at least one of alarm information and information for prompting shutdown and overhaul.

The communication bus 803 mentioned in the above electronic device may be a peripheral component interconnect (PCI) bus, an extended industry standard architecture (EISA) bus, or the like. The communication bus 803 may be classified as an address bus, a data bus, a control bus, or the like. For ease of representation, only one thick line is used in FIG. 8, but it does not mean that there is only one bus or one type of bus.

The memory 802 may be a read-only memory (ROM), a random-access memory (RAM), a phase-change random-access memory (PRAM), a static random-access memory (SRAM), a dynamic random-access memory (DRAM), an electrically erasable programmable read-only memory (EEPROM), another type of random-access memory (RAM), a flash drive or another form of flash memory, a cache, a register, a static memory, a compact disc read-only memory (CD-ROM), a digital versatile disc (DVD) or another optical memory, a cassette tape or another magnetic storage device, or any other possible non-transitory medium used for storing information or instructions that can be accessed by a computer device. Optionally, the memory may also be at least one storage apparatus located away from the above processor 801.

The above processor 801 may be a processing device including one or more general processing devices, such as a microprocessor, a central processing unit (CPU), and a graphics processing unit (GPU). More specifically, the processor may be a complex instruction set computer (CISC) microprocessor, a reduced instruction set computer (RISC) microprocessor, a very long instruction word (VLIW) microprocessor, a processor running another instruction set, or a processor running a combination of instruction sets. The processor may also be one or more dedicated processing devices, such as an application-specific integrated circuit (ASIC), a field-programmable gate array (FPGA), a digital signal processor (DSP), or a system on a chip (SoC).

An electronic device in this embodiment of the present disclosure may include, but is not limited to, a fixed terminal device such as a server, a desktop computer, or a digital TV, and a mobile terminal device such as an in-vehicle device (for example, a head-up display device), a handheld device (for example, a mobile phone or a tablet computer), or a wearable device (for example, a smart watch or a smart band).

In another embodiment of this application, a computer-readable storage medium is further provided. The computer-readable storage medium stores a computer program. When the computer program is executed on a computer, the computer executes the packing leakage detection method described in the above embodiment.

The computer-readable storage medium in this embodiment of the present disclosure may be any combination of one or more computer-readable mediums. The computer-readable medium may be a computer-readable signal medium or a computer-readable storage medium. The computer-readable storage medium may be, for example, but is not limited to, an electric, magnetic, optical, electromagnetic, infrared, or semi-conductive system, apparatus, or component, or any combination thereof. In the embodiments of the present disclosure, the computer-readable storage medium may be any tangible medium including or storing a program, and the program may be used by or in combination with an instruction execution system, apparatus or component, for example, may be the foregoing memories.

A computer program in this embodiment of the present disclosure may be organized into one or more computer-executable components or modules. Any number and combination of such components or modules may be used to implement the aspects of the present disclosure. For example, the aspects of the present disclosure are not limited to specific computer-executable instructions or specific components or modules shown in the accompanying drawings and described in this specification. Other embodiments may include different computer-executable instructions or components having more or less functions than those shown and described herein.

In the above embodiment, it can be fully or partially implemented through software, hardware, firmware, or any combination thereof. When implemented using software, it can be fully or partially implemented in the form of a computer program product. The computer program product includes one or a plurality of computer instructions. When the computer instruction is loaded and executed on the computer, all or part of the processes or functions described in the embodiments of this application are generated. The computer may be a general-purpose computer, a special-purpose computer, a computer network, or other programmable devices. The computer instruction may be stored in a computer-readable storage medium, or transmitted from one computer-readable storage medium to another computer-readable storage medium. For example, the computer instruction is transmitted from one website, computer, server or data center via wired (such as coaxial cable, optical fiber and digital subscriber line (DSL)) or wireless (such as infrared and microwave) modes to another website, computer, server or data center. The computer-readable storage medium may be any available medium that the computer can access, or a data storage device such as a server or a data center that integrates one or a plurality of available media. The available medium may be a magnetic medium (such as a floppy disk, a hard disk or a magnetic tape), an optical medium (such as a DVD), a semiconductor medium (such as a solid state disk), or the like.

It should be noted that in the description of this application, orientation or position relationships indicated by the terms such as “transverse”, “longitudinal”, “above”, “below”, “front”, “rear”, “left”, “right”, “vertical”, “horizontal”, “top”, “bottom”, “inside” and “outside” are based on orientation or position relationships shown in the accompanying drawings, and are only for the convenience of describing this application and simplifying the description, rather than indicating or implying that the mentioned apparatus or component needs to have a specific orientation or needs to be constructed and operated in a specific orientation. Therefore, this should not be understood as a limitation on this application.

It should be noted that the relational terms herein such as “first” and “second” are used only to differentiate an entity or operation from another entity or operation, and do not require or imply any actual relationship or sequence between these entities or operations. Moreover, the terms “include,” “comprise,” and any variation thereof are intended to cover a non-exclusive inclusion. Therefore, a process, method, article or device including a series of elements includes not only those elements, but also other elements that are not explicitly listed, or further includes elements inherent to such process, method, article or device. If no more limitations are made, an element limited by “include one . . . ” does not exclude other same elements existing in the process, method, article or device which includes the element.

The above descriptions are only specific implementations of the present invention to ensure that a person skilled in the art can understand or implement the present invention. Various modifications to these embodiments are obvious to a person skilled in the art, and the general principles defined in the present invention may be implemented in other embodiments without departing from the spirit or scope of the present invention. Therefore, the present invention is not limited to these embodiments illustrated herein, but conforms to the broadest scope consistent with the principles and novel features disclosed in the present invention.

What is claimed is:

1. A method for monitoring a packing status of a plunger pump, comprising:
obtaining packing pressure measurements from a pressure detector, the pressure detector being disposed within a packing cavity and between two packing components of a packing, the two packing components being arranged in tandem and each having a cross section with a V-shape for sealing between a wall of the packing cavity and an outer surface of a plunger of the plunger pump, and the sealing being pressure-assisted via a pressure exerted from an open side of the V-shape by a pressurized fluid from a hydraulic-end valve box of the plunger pump; and
monitoring the packing status of the plunger pump based on the packing pressure measurements.

2. The method according to claim 1, wherein the packing cavity comprises a first contact position between the hydraulic-end valve box and the packing, a second contact position between the hydraulic-end valve box and a packing pressing cap, a third contact position between the hydraulic-end valve box and a packing pressing ring, and a fourth contact position between the hydraulic-end valve box and a packing isolating ring.

3. The method according to claim 1, wherein monitoring the packing status of the plunger pump is further based on a discharge pressure of the hydraulic-end valve box in addition to the packing pressure measurements, and comprises:
determining whether the discharge pressure reaches a pressure-assisted packing sealing pressure;
when the discharge pressure reaches the pressure-assisted packing sealing pressure, determining whether the packing pressure measurements indicate a packing pressure exceeding a preset packing pressure threshold; and
when it is indicated that the packing pressure exceeds the preset packing pressure threshold, determining that the packing is abnormal.

4. The method according to claim 3, wherein the preset packing pressure threshold comprises a plurality of thresholds determined based on packing abnormality levels, and determining whether the packing pressure exceeds a preset packing pressure threshold comprises:
comparing the packing pressure in a level by level manner with the plurality of thresholds sorted in ascending order to determine the packing status.

5. The method according to claim 3, wherein before determining whether the discharge pressure reaches the pressure-assisted packing sealing pressure, the method further comprises:
determining whether an operating status of the plunger pump and the discharge pressure of the hydraulic-end valve box are stable; and
determining whether the discharge pressure reaches a pressure-assisted packing sealing pressure comprises:
when the operating status of the plunger pump and the discharge pressure of the hydraulic-end valve box are stable, determining an operating condition of the plunger pump based on the operating status of the plunger pump; and
determining, in the operating condition, whether the discharge pressure reaches the pressure-assisted packing sealing pressure.

6. The method according to claim 5, wherein determining whether an operating status of the plunger pump is stable comprises:
obtaining running status information of the plunger pump through a running detector arranged at one end of a crankshaft of the plunger pump, wherein the running status information of the plunger pump comprises at least one of a running speed of the plunger pump, crank position information of the crankshaft of the plunger pump, and plunger position information, and wherein the running detector comprises a uniformly-toothed trigger wheel or comprises a tooth-missing trigger wheel and a key phase sensor; and
determining, based on the running status information, whether the operating status of the plunger pump is stable.

7. The method according to claim 3, further comprising:
generating corresponding alarm prompt information based on an abnormality status of the packing, wherein:
the alarm prompt information comprises identification of at least one cylinder with a packing abnormality, abnormality level information, and abnormality handling information.

8. The method of claim 7, wherein the alarm prompt information is indicated via colored light.

9. A plunger pump, comprising:
a hydraulic end comprising valve box and a plunger chamber disposed in sequence;
a plunger movably disposed within the plunger chamber, an inner wall of the plunger chamber and an outer surface of the plunger forming a packing cavity;
a packing disposed in the packing cavity, the packing comprises at least two packing components being arranged in tandem with each having a cross section with a V-shape for a sealing between the inner wall of the plunger chamber and the outer surface of the plunger, and the sealing being assisted via a pressure exerted from a pressurized fluid from the valve box; and
at least one pressure sensor disposed between the two packing components.

10. The plunger pump according to claim 9, further compressing a control circuitry, wherein the control circuitry is configured to monitor a packing status of the plunger pump based on measurements of a packing pressure from the at least one pressure sensor.

11. The plunger pump according to claim 10, wherein the control circuitry is configured to monitor the packing status based on a discharge pressure of the valve box in addition to the packing pressure measurements by:
determining whether the discharge pressure reaches a pressure-assisted packing sealing pressure;
when the discharge pressure reaches the pressure-assisted packing sealing pressure, determining whether the packing pressure measurements indicate a packing pressure exceeding a preset packing pressure threshold; and
when it is determined that the packing pressure exceeds the preset packing pressure threshold, determining that the packing is abnormal.

12. The apparatus according to claim 11, wherein the preset packing pressure threshold comprises a plurality of thresholds determined based on packing abnormality levels, and the at least one processor is configured to execute the computer instructions to determine whether the packing pressure exceeds a preset packing pressure threshold by:
comparing the packing pressure in a level by level manner with the plurality of thresholds sorted in ascending order to determine the packing status.

13. The plunger pump according to claim 11, wherein before determining whether the discharge pressure reaches a pressure-assisted packing sealing pressure, the control circuitry is configured to:
determine whether an operating status of the plunger pump and the discharge pressure of the valve box are stable; and
determine whether the discharge pressure reaches a pressure-assisted packing sealing pressure by:
when the operating status of the plunger pump and the discharge pressure of the valve box are stable, determining an operating condition of the plunger pump based on the operating status of the plunger pump; and
determining, in the operating condition, whether the discharge pressure reaches the pressure-assisted packing sealing pressure.

14. The plunger pump according to claim 13, wherein the control circuitry is configured to determine whether an operating status of the plunger pump is stable by:
obtaining running status information of the plunger pump through a running detector arranged at one end of a crankshaft of the plunger pump, wherein the running status information of the plunger pump comprises at least one of a running speed of the plunger pump, crank position information of the crankshaft of the plunger pump, and plunger position information, and wherein the running detector comprises a uniformly-toothed trigger wheel or comprises a tooth-missing trigger wheel and a key phase sensor; and
determining, based on the running status information, whether the operating status of the plunger pump is stable.

15. The plunger pump according to claim 11, wherein the control circuitry is further configured to:
generate corresponding alarm prompt information based on an abnormality status of the packing, wherein:
the alarm prompt information comprises identification of at least one cylinder with a packing abnormality, abnormality level information, and abnormality handling information.

16. The plunger pump according to claim 15, wherein the alarm prompt information is indicated via colored light.

17. A plunger-packing assembly, comprising:
a plunger movably disposed within a plunger chamber having an inner wall to form a packing cavity between the plunger and the inner wall;
a packing disposed in the packing cavity for a sealing between the plunger and the inner wall, the packing comprising two packing components being arranged in tandem, each of the two packing components having a cross section with a V-shape, and the sealing being assisted via a pressure exerted from an open side of the V-shape by a pressurized fluid; and
a pressure detector disposed between the two packing components for packing pressure measurements used for determining a status of the sealing.

18. The plunger-packing assembly of claim 17, further comprising a packing pressure cap, a packing pressure ring, and a packing isolation ring, wherein the packing cavity comprises a first contact position between a hydraulic-end valve box and the packing, a second contact position between the hydraulic-end valve box and the packing pressing cap, a third contact position between the hydraulic-end valve box and the packing pressing ring, and a fourth contact position between the hydraulic-end valve box and the packing isolating ring.

19. The plunger-packing assembly of claim 17, further comprising a discharge pressure sensor disposed at the open side of the V-shape for measuring the pressurized fluid.

20. The plunger-packing assembly of claim 17, wherein:
the two packing components, when disposed in tandem, forms an accommodation space between the open side of the V-shape of one of the two packing components and a tip end of the V-shape of another of the two packing components; and
the pressure detector is disposed in the accommodation space.
